(19) United States
(12) Patent Application Publication
(10) Pub. No.: US 2008/0280028 A1
(43) Pub. Date: Nov. 13, 2008

(54) Method and device for coating a surface

(75) Inventors: Ludwig Albrecht, Dornstetten-Aach (DE); Karl Frey, Schopfloch (DE); Achim Gauss, Dornstetten/Hallwangen (DE)

Correspondence Address: BAKER BOTTS L.L.P., 30 ROCKEFELLER PLAZA, 44TH FLOOR, NEW YORK, NY, 10112-4498, US

(73) Assignee: Homag Holzbearbeitungssysteme AG, Schopfloch (DE)

(21) Appl. No.: 12/118,389

(22) Filed: May 9, 2008

(30) Foreign Application Priority Data
May 10, 2007 (EP) 07 009 417.2

(51) Int. Cl. B05D 5/00; B05C 11/10

(52) U.S. Cl. 427/8; 118/712

(57) ABSTRACT

The invention relates to a method for coating a surface of an article (2), including the following steps: providing an article (2), in particular a workpiece, which is to be coated on one surface, and producing a coating on the surface to be coated of the article (2) by means of a coating head (10), in particular an ink-jet head, which has a plurality of outlets (12) for the coating material. The method according to the invention is characterised in that, prior to the production of a coating, a desired gloss value of the coated surface is selected from a gloss scale, preferably measured as a reflectometer value to ISO 2817, and the coating material is ejected out of the outlets (12) onto the surface to be coated in such a way that the selected gloss value of the coated surface is obtained.

### TECHNICAL FIELD

The invention relates to a method for coating a surface of an article, in particular a workpiece, according to the preamble of claim 1 and to a device for carrying out the method.

### PRIOR ART

A broad range of methods and devices are known for coating and, if appropriate, patterning articles such as, for example, plate-like workpieces in the field of the furniture industry.

Thus, for example, EP 1 726 443 A1 discloses a method and a device for coating and simultaneously patterning the narrow faces of plate-like workpieces by means of an ink-jet printhead. In this way, any desired patterns can be produced on the surface of the workpiece. Nevertheless, it has been found that the applied pattern, depending on the motif (for example a wood or natural stone grain), is felt, despite the high print resolution, to be insufficiently realistic or authentic, i.e. the overall appearance of the applied coating is in need of improvement.

### PRESENTATION OF THE INVENTION

The object of the present invention is to provide a method and a device of the type mentioned at the outset that allow an improved overall appearance of a coated surface.

According to the invention, this object is achieved by a method according to claim 1 and a device for carrying out the method according to claim 8. Particularly advantageous developments of the invention are set out in the dependent claims.

The invention is based on the recognition that the overall appearance of a coated surface depends not only on the colour/the pattern of the coated surface but rather to a significant extent also on the light reflection capacity or the gloss of the coated surface. In particular, conventional, generic coating methods do not involve purposeful matching between the colour/the pattern of the coated surface, on the one hand, and the gloss of the coated surface, on the other hand. Against this background, the invention provides that in the case of a generic method, prior to the production of a coating, a desired gloss value of the coated surface is selected from a gloss scale, preferably measured as a reflectometer value to ISO 2817, and that the coating material is ejected out of the outlets onto the surface to be coated in such a way that the selected gloss value of the coated surface is obtained.

This opens up entirely new possibilities for configuring the appearance of coated surfaces of articles. Thus, the degree of gloss can be purposefully adapted to the respective motif of the coated surface in order to achieve an optimum, high-quality appearance harmonising the gloss and motif. In addition, the purposeful application of the coating material allows not only the visual appearance but also the feel of the coated surface to be optimised in that the surface structure can be adapted to the respective motif of the coated surface. For example, the applied coating can be used to imitate a leather feel or the feel of a wood grain, whereas at the same time the gloss value, which may vary along the coated surface, of the material can also be imitated or adjusted as desired.

Furthermore, the method according to the invention can be carried out using comparatively simple means, for example as a result of the fact that no additional components such as embossing rollers or the like are required to achieve the selected gloss value.

Not least, the method according to the invention allows highly flexible production, as the method can be used to manufacture in a simple manner every single workpiece individually (single-unit manufacture) without the need for conversion operations.

In conjunction herewith, a development of the invention provides for at least two articles to be coated with a predetermined coating material, in particular a predetermined type of ink, in such a way that the gloss value of the coated surface of at least one article differs from that of at least one other article. This method does not require the machine to be reconfigured for each change of the gloss value of differing workpieces (for example a different coating material, different embossing rollers, etc.); on the contrary, production is able to proceed continuously with a single machine configuration. This significantly reduces downtimes and sources of error.

Although, within the scope of the invention, the coating of the article does not have to affect a motif which may already be provided on the article, a development of the invention provides for the coating process to provide the article with a pattern and/or a surface structure. In this way, the number of method steps may, in the case of patterned or structured workpieces, be reduced, as the coating process according to the invention can be used not only to achieve the selected gloss value but rather at the same time also to achieve a desired pattern and/or surface structure or feel.

Furthermore, a development of the invention provides for the coating material to be at least semi-transparent, preferably transparent. In this case, the primary function of the coating material can be purposefully to set the selected gloss value whereas a motif located below the applied coating continues to remain wholly or partly visible.

In order to achieve an optimum appearance, in particular in the case of such visual interplay of the coating material and surface located therebelow, a development of the invention provides for the gloss value of the surface to be coated to be read in or determined and for the application of the coating material to be carried out while taking into account the gloss value of the surface to be coated in order to achieve the selected gloss value of the coated surface. This allows the achievement of purposefully reproducible results in which the coordination of the coated surface and applied coating material gives rise to a surface having a desired motif, a desired degree of gloss and optionally a desired feel.

To achieve the selected gloss value, the method according to the invention allows for variation of a broad range of influencing variables or parameters. However, the inventors have ascertained that certain main parameters are particularly suitable for reliably and reproducibly varying the degree of gloss in a simple and effective manner. Against this background, a development of the invention provides for the variation of at least one parameter, which is selected from drop size, drop spacing, drying time, nature and properties of the ejected coating material, for achieving the selected gloss value.

The gloss value of the coated surface is, as mentioned at the outset, preferably measured as a reflectometer value to ISO 2817, a 200 reflectometer value having been found to be a significant variable for a large number of applications.

The method according to the invention can be carried out particularly simply, promptly and efficiently using a device having the features of claim 8. This device is distinguished in that it comprises a control means which is configured to control the coating head in such a manner that the coating material is ejected out of the outlets onto the surface to be coated in such a way that the selected gloss value of the coated surface is obtained. As stated hereinbefore, this eliminates the need for expensive additional components such as a plurality of embossing rollers, differing storage containers for coating materials, etc. Instead, the variability of the gloss value that the invention seeks to achieve is obtained by a small number of mutually adapted components, namely in the first place the printhead and the control means which is configured to achieve the gloss value.

In order to be able precisely and flexibly to define the desired gloss value, a development of the invention provides for the device also to comprise an input means for inputting a selected gloss value of the coated surface.

In particular, if the device is intended to process a semi-transparent or transparent coating material, a development of the invention provides for the device also to comprise a measuring means for measuring a gloss value, in particular a reflectometer value to ISO 2817, of a coated surface and/or a surface to be coated of the article. It can thus be ensured that the interplay of the gloss value of the surface to be coated and the parameters of the coating to be applied yields, as a whole, the desired gloss value.

### BRIEF DESCRIPTION OF THE DRAWINGS

FIG. 1 is a schematic perspective view of an embodiment of the device according to the invention;

FIG. 2 is a schematic plan view of a printhead which can be used within the scope of the present invention; and

FIG. 3 shows schematically detailed views of workpieces which are coated in accordance with the invention.

### DETAILED DESCRIPTION OF PREFERRED EMBODIMENTS

Preferred embodiments of the present invention will be described hereinafter in detail with reference to the accompanying drawings.

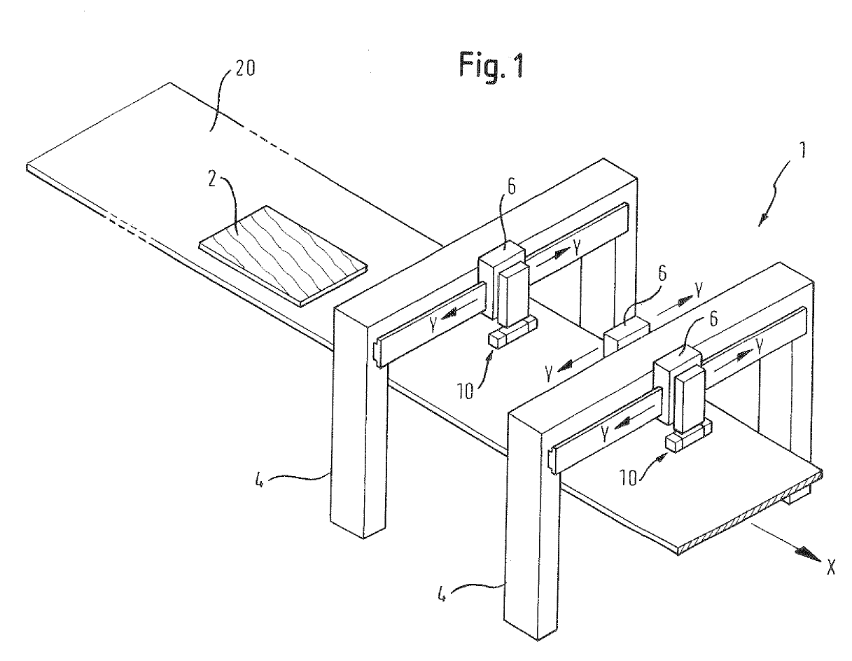

FIG. 1 shows schematically a device 1 according to the invention for coating a surface of an article 2 as a preferred embodiment of the present invention. The articles 2 to be coated may, for example, be plate or strip-like workpieces such as are frequently used in the field of the furniture industry and preferably consist at least partly of wood, wood materials, plastics material or the like. However, it will be noted that the present invention can also be applied to other types of workpieces or articles.

The device 1 has firstly a conveyor means 20 which can be configured, for example, in the form of a conveyor belt, a conveyor table, a conveyor chain or the like. Two portals 4, which can for example also be configured as jibs or the like, are disposed above the conveyor means 20 in the present embodiment. At least one respective coating head 10, which can be moved along the portal 4 via a carriage 6, is disposed on the portals 4. In addition to the coating heads 10, further units, for example machining units for carrying out material removal or other machining operations, edge-banding units, pretreatment or subsequent treatment units, etc., can also be disposed on the portals 4.

It will also be noted that, in the device 1, the workpiece 2 can also be disposed to be in each case stationary and that, alternatively, the portals 4 can be configured so as to be movable, that the machine is therefore a stationary machine such as is frequently used in the field of CNC technology. Combinations of continuously operating and stationary machines are also possible within the scope of the present invention.

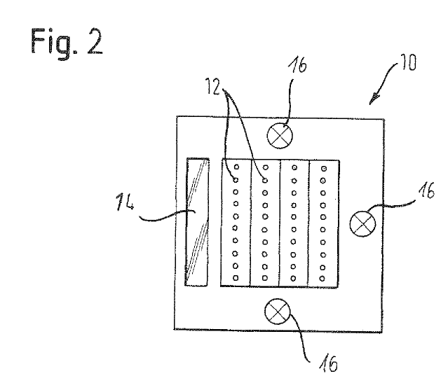

FIG. 2 shows schematically an example of the configuration of the coating head. In this example, the coating head has a plurality of outlets 12 for the coating material which may, for example, be ink, paint or other hardenable materials. The coating head 10 also has distance sensors 16 in order to allow more precise relative positioning between the coating head 10 and workpiece 2. Furthermore, the coating head 10 has a measuring means 14 for measuring a gloss value, in particular a reflectometer value to ISO 2817, of a coated surface and/or a surface to be coated of the article 2. The measuring means 14 can in this regard be disposed in such a way that it detects the gloss value of the surface either before or after the coating process is carried out. The measuring means may, for example, be an apparatus of the 406 Novo Gloss type from Elcometer (www.elcometer.com).

Although not shown in the figures, the device 1 also comprises a control means which is configured to control the coating head 10 in such a way that the coating material is ejected out of the outlets 12 onto the surface to be coated of the workpiece 2 in such a way that a selected gloss value of the coated surface, for example a gloss value selected using an input means (not shown in detail), is obtained.

Within the scope of the present invention, the gloss value can be represented by a broad range of parameters, a 200 reflectometer value to ISO 2817 having been found, in particular, to be a suitable variable for the gloss value. Although the present invention is not limited hereto, the production or variation of a predetermined gloss value when coating a surface is ultimately based on the fact that the coated surface obtained is a surface structure which influences the reflection capacity of the surface when light falls on it. It has in this regard been found to be particularly effective and simple, for achieving a selected gloss value, to vary one or more of the following parameters: drop size and drop spacing of the coating material which is applied by means of the coating head, the drying time of the coating material and the nature and properties of the coating material.

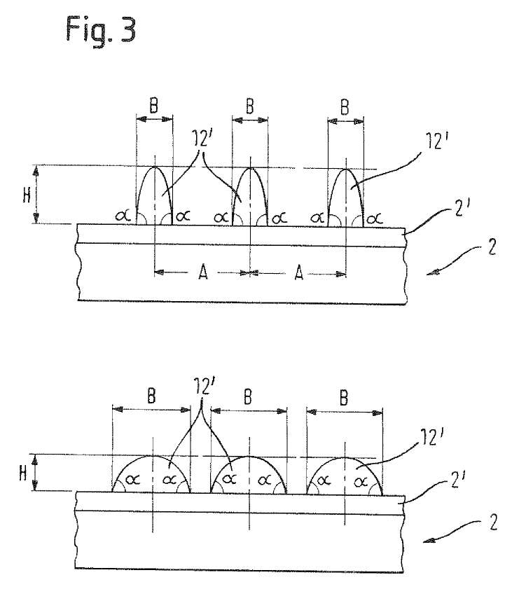

Purely by way of example, the influence of the drying time of the coating material on the surface structure, and thus on the gloss value of the coated surface, may be described with reference to FIG. 3 which shows schematically detailed views of workpieces which have been coated in accordance with the invention. The upper drawing in FIG. 3 shows a case in which a relatively quick-drying or hardening coating material 12′ has been used, so the material 12′ has little time to run on the surface of the workpiece 2, thus resulting in a comparatively small width B and a relatively high height H of the individual drops of the coating material 12′ on the surface. Generally speaking, this leads to a relatively low gloss value, i.e. to a matt surface.

In the lower drawing in FIG. 3, use has been made conversely of a coating material which dries or hardens more slowly, resulting in a larger width B and a lower height H of the individual drops of the coating material 12′ than in the preceding case. This tends to lead to a higher gloss value.

Similar relationships apply to the remaining parameters. For example, a relatively small drop spacing and a relatively large drop size tend to lead to a less pronounced structure and thus to a higher gloss value.

Furthermore, FIG. 3 shows an example in which the workpiece 2 is provided on its surface with a decoration or pattern 2′ even before the coating compound 12′ has been applied. In this case, it is advisable to apply a transparent or semi-transparent coating material 12′, so the pattern 2′ continues to remain at least partly visible. However, it is in this regard advantageous when applying the coating material to allow for the gloss value of the pre-existing decoration 2′ and to achieve the desired gloss value as a result of the interplay of both surfaces. For this purpose, the above-mentioned measuring means 14 can, for example, be used in order first to determine the gloss value of the pattern 2′ and then to carry out the subsequent coating process in such a way as to produce, overall, the desired gloss value which is composed of the properties of the existing pattern 2′ and of the coating material 12′.

Alternatively or additionally, it is likewise possible to use the coating material also to provide a pattern, thus allowing the pattern 2′ shown in FIG. 3 to be dispensed with if appropriate. Not least, the coating material 12′ can also be used to impart a specific feel, for example a leather or wood feel, to the surface.

The method according to the invention is also distinguished as a result of the fact that the device 1 does not have to be converted in order to achieve the desired, variable gloss values. On the contrary, the method according to the invention and the device according to the invention readily allow workpieces continuously to be provided with a coating and thus to achieve using a (single) coating material—within certain limits—at all times the desired gloss value of the surface. In other words, the present invention does not require any varying coating materials, embossing rollers or the like in order to achieve a broad range of degrees of gloss of the coated surface in a large number of workpieces.

1-10. (canceled)

11. A method for coating a surface of an article, including the following steps: providing an article, wherein the article is a workpiece, which is to be coated on one surface, producing a coating on the surface to be coated of the article by means of a coating head which has a plurality of outlets for the coating material, wherein,
prior to the production of a coating, a desired gloss value of the coated surface is selected from a gloss scale, measured as a reflectometer value to ISO 2817, and
the coating material is ejected out of the outlets onto the surface to be coated in such a way that the selected gloss value of the coated surface is obtained.

12. A method according to claim 11, wherein the coating material is a predetermined type of ink.

13. A method according to claim 11, wherein that at least two articles are coated with a predetermined coating material, in such a way that the gloss value of the coated surface of at least one article differs from that of at least one other article.

14. A method according to claim 11, wherein that the article is provided with a pattern and/or a surface structure by the coating process.

15. A method according to claim 11, wherein the coating material is transparent or semi-transparent.

16. A method according to claim 12, wherein the gloss value of the surface to be coated is read in or determined, and wherein the application of the coating material is carried out taking into account the gloss value of the surface to be coated in order to achieve the selected gloss value of the coated surface.

17. A method according to claim 11, wherein at least one parameter selected from drop size, drop spacing, drying time, nature and properties of the ejected coating material, is varied to achieve the selected gloss value.

18. A method according to claim 13, wherein the coated surface has a gloss value, measured as a 200 reflectometer value to ISO 2817, at least in certain portions.

19. A device for carrying out the method according to claim 11, comprising:
a coating head for imprinting, a surface of an article, the coating head having a plurality of outlets for the coating material, and
a conveyor for bringing about a relative movement between the coating head and the article to be coated,
wherein,
the device also comprises a control means which is configured to control the coating head in such a manner that the coating material is ejected out of the outlets onto the surface to be coated in such a way that the selected gloss value of the coated surface is obtained.

20. A device according to claim 19, wherein the coating head is an ink jet head.

21. A device according to claim 19, further comprising an input means for inputting a selected gloss value of the coated surface.

22. A device according to claim 19, further comprising a measuring means for measuring a gloss value, in particular a reflectometer value to ISO 2817, of a coated surface and/or a surface to be coated of the article.
